(19) United States
(12) Patent Application Publication
(10) Pub. No.: US 2023/0126887 A1
(43) Pub. Date: Apr. 27, 2023

(54) HOLDER FOR MOBILE RADIO COMMUNICATION DEVICE

(71) Applicant: Zekeriya KONDUOGLU, Schwelm (DE)

(72) Inventor: Zekeriya KONDUOGLU, Schwelm (DE)

(21) Appl. No.: 17/974,831

(22) Filed: Oct. 27, 2022

(30) Foreign Application Priority Data
Oct. 27, 2021 (DE) DE 102021127956.9

(51) Int. Cl. H04M 1/04

(52) U.S. Cl. CPC H04M 1/04

(57) ABSTRACT

A holder for a mobile radio communication device configured as a mobile phone or smart phone, the holder including a flat rectangular housing into which the mobile radio communication device is insertable; and a flexible band attached at a first long side of the flat rectangular housing. In order for the mobile radio communication device to be supportable in one hand essentially by one finger a fastening element configured as a hook arranged at a second long side of the housing opposite to the first long side of the housing where the flexible band is attached is provided wherein the hook is engageable by the band.

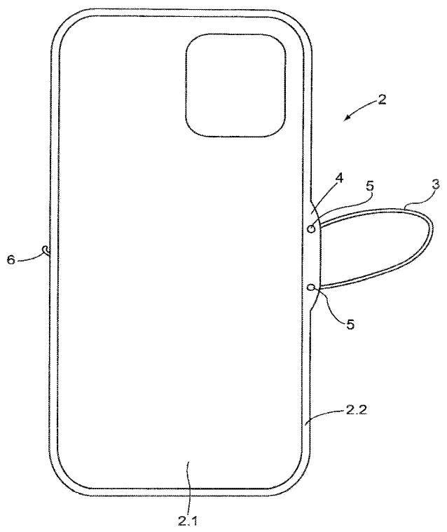

### RELATED APPLICATIONS

This application claims priority from German Patent Application DE 10 2021 127 956.9 filed on Oct. 27, 2021 which is incorporated in its entirety by this reference.

### FIELD OF THE INVENTION

The invention relates to a holder for a mobile radio communication device configured as a mobile telephone and/or smart phone including a flat rectangular housing into which the mobile radio communication device is insertable and an elastic band attached at a long side of the housing.

### BACKGROUND OF THE INVENTION

DE 20 2013 004 269 U1 discloses a generic holder. The band is configured to hang the mobile radio communication device, thus a tablet around a person's neck.

DE 20 2019 003 167 U1 discloses a mobile phone holder including a support including double sided adhesive tape strips on a back side and two protrusions on a front side and rings configured to attach bands through carabiner hooks or loop.

### BRIEF SUMMARY OF THE INVENTION

It is an object of the invention to provide a holder for a mobile radio communication device configured as a mobile phone and/or smartphone, wherein the holder is configured so that the mobile phone or smart phone inserted into the holder is supportable by one hand essentially by a single finger so that in particular a thumb of the hand is available for operating a keyboard of the mobile radio communication device.

The object is achieved by a holder for a mobile radio communication device configured as a mobile phone or smart phone, the holder including a flat rectangular housing into which the mobile radio communication device is insertable; and a flexible band attached at a first long side of the flat rectangular housing; a fastening element configured as a hook arranged at a second long side of the flat rectangular housing opposite to the first long side of the flat rectangular housing, wherein the hook is engageable by the flexible band.

The band is advantageously attached at a long side of the housing, advantageously at a support body arranged at the housing which advantageously includes two openings configured to pass the band through.

The band is advantageously made from a luminescent material so that the holder can also be located when it is dark.

### BRIEF DESCRIPTION OF THE DRAWINGS

The invention is now described based on an advantageous embodiment with reference to a drawing FIGURE showing a rear view of the holder according to the invention.

### DETAILED DESCRIPTION OF THE INVENTION

The drawing FIGURE illustrates the holder according to the invention including a flat housing 2 including a plate 2.1 partially enveloped by a flat rim 2.2.

The housing includes a support body 4 including two openings 5 configured to pass a band 3 through that is made from an elastic material.

A hook shaped fastening element 6 is arranged at a long side of the housing arranged opposite to the support body 4 so that the elastic band contacts a back side of the housing 1 when the elastic band is hooked up in the hook shaped fastening element 6 and so that flat card shaped elements can be clamped between a rear wall of the housing and the elastic band 3.

The elastic band 3 is advantageously made from a luminescent material so that the housing 2 with the mobile communication device inserted therein can also be located in darkness.

### REFERENCE NUMERALS AND DESIGNATIONS

2 housing

2.1 plate

2.2 rim

3 band

4 support body

5 opening

6 fastening element

What is claimed is:

1. A holder for a mobile radio communication device configured as a mobile phone or smart phone, the holder comprising:
a flat rectangular housing into which the mobile radio communication device is insertable; and
a flexible band attached at a first long side of the flat rectangular housing; and
a fastening element configured as a hook arranged at a second long side of the flat rectangular housing opposite to the first long side of the flat rectangular housing, wherein the hook is engageable by the flexible band.

2. The holder according to claim 1, further comprising a support body configured at the first long side of the flat rectangular housing wherein the flexible band is attached at the support body.

3. The holder according to claim 2, wherein the support body includes two openings configured to pass the flexible band through and retain the flexible band.

4. The holder according to claim 1, wherein in the flexible band is made from a luminescent material.

5. The holder according to claim 1, wherein the flat rectangular housing includes a plate that includes a flat rim at least at a portion of a circumference of the plate.
